(19) United States
(12) Patent Application Publication
(10) Pub. No.: US 2026/0142788 A1
(43) Pub. Date: May 21, 2026

(54) SYSTEM FOR TRANSMITTING A SIGNAL WITH A DATA PACKET TO AND FROM A CONTROLLER OF A PLURALITY OF CONTROLLERS

(71) Applicant: Erwin STADLER, Verl (DE)

(72) Inventor: Jörg SCHNECK, Friedrichsdorf (DE)

(21) Appl. No.: 19/116,673

(22) PCT Filed: Sep. 29, 2023
(86) PCT No.: PCT/EP2023/077127

§ 371 Date: Mar. 28, 2025

(30) Foreign Application Priority Data
Sep. 30, 2022 (DE) 10 2022 125 428.3

(51) Int. Cl. H04L 5/14

(52) U.S. Cl. CPC H04L 5/14

(57) ABSTRACT

A system includes a plurality of meshed, packet-based communication channels for full-duplex signal transmission, a plurality of controllers as data receivers or data sources, wherein each of the plurality of controllers includes an interface for connecting at least one sensor or one actuator, a data processing device and exactly one transceiver, wherein the exactly one transceiver is connected to exactly one of the plurality of communication channels at any point in time, and at least one infrastructure component. The infrastructure component includes a data processing device and at least two transceivers, wherein each transceiver is connected to exactly one of the communication channels at any point in time. The communication channels are divided between a first subnet and a second subnet with all carrier frequencies of a signal transmission in the first subnet being different from all carrier frequencies of the signal transmission in the second subnet.

The present invention relates to a system comprising a plurality of meshed, packet-based communication channels for full-duplex signal transmission to and from a plurality of controllers as data receivers or data sources, wherein each of the plurality of controllers comprises an interface for connecting at least one sensor or one actuator, a data processing device and a transceiver, as well as at least one infrastructure component.

Such systems or data networks for connecting sensors, for example twilight sensors, and actuators, for example relays for switching on lights, are known from the prior art in a variety of ways. Such systems are necessary to connect a large number of elements positioned at different locations, for example distributed across a building or a city, to exchange information and to logically link them together for various applications. Examples of such applications include car park recognition and allocation of free parking spaces via a smartphone app, a waste management system that detects and reports full waste bins or a lighting control system. The applications provide services that are not available without the corresponding networking of sensors and actuators and that can also help to reduce resource consumption, especially energy consumption.

The aim of modern network infrastructures is to connect a large number of sensors and actuators and the associated end devices with low operating costs. Conventional wireless wide area networks (WAN) make it possible to transmit data at high data rates over larger distances. However, this requires a comparatively high amount of energy. As a result, controllers that are connected to sensors cannot be provided with a battery-based power supply independently of the supply network.

So-called Low Power Wide Area Networks (LPWAN) enable wireless communication over larger distances between sensors and actuators, wherein the controllers can be operated with a battery due to the low energy requirements. In LPWANs, data transmission is energy-efficient even over larger distances. However, the available data rates are too low for more complex applications.

In contrast, one object of the present invention is to provide a system for data transmission from and to controllers that can be connected to sensors and actuators, which makes it possible to bridge large distances between the individual elements of the system, is energy-efficient and at the same time enables data rates that are higher than those of conventional LWPAN technologies.

According to the invention, this object is solved by a system with the features of independent claim 1. For this purpose, the system comprises a plurality of meshed, packet-based communication channels for full-duplex signal transmission and a plurality of controllers as data receivers and data sources, wherein each of the plurality of controllers comprises an interface for connecting at least one sensor or an actuator, a data processing device and exactly one transceiver. The exactly one transceiver is connected to exactly one of the plurality of communication channels at any point in time. In addition, the system comprises at least one infrastructure component, wherein the infrastructure component comprises a data processing device and at least two transceivers, wherein each of the at least two transceivers is connected to exactly one of the plurality of communication channels at any point in time. The plurality of communication channels is divided into at least a first subnet and a second subnet, wherein all carrier frequencies of a signal transmission in the first subnet are different from all carrier frequencies of a signal transmission in the second subnet. The system is configured to transmit a signal comprising a data packet to and from one of the plurality of controllers. Transmitting the signal comprises forwarding the data packet by the at least one infrastructure component, wherein in the forwarding the at least one infrastructure component receives the data packet on a first one of the plurality of communication channels and transmits the data packet on a second one of the plurality of communication channels, wherein the first communication channel is part of the first subnet and the second communication channel is part of the second subnet.

It is the advantage of the present invention to be able to provide a system architecture that enables wireless operation in a license-free and permission-free frequency band, which provides a sufficiently high bandwidth for more complex applications. The claimed solution nevertheless makes it possible to bridge larger distances despite the reduction in radio range associated with high carrier frequencies. The construction of larger networks is possible.

The basic idea of the present invention is to operate the first and second subnets with carrier frequencies that are different from each other. The at least one infrastructure component, which is responsible for forwarding a data packet from the first subnet to the second subnet, has two transceivers, one of which is connected to a transmission channel of the first subnet with a first carrier frequency and the other of which is connected to a transmission channel of the second subnet with a second carrier frequency. The infrastructure component can also be referred to as a repeater in the sense that the range of the system is increased.

With conventional repeating of a signal on a single communication channel with a carrier frequency, the bandwidth is reduced by the repeating. In contrast, forwarding according to the invention does not lead to a reduction in the available bandwidth. However, the latency is increased by forwarding a data packet.

A majority of the communication channels, preferably all communication channels, of the system operate with full-duplex signal transmission according to the invention. In other words, data can be transmitted in both directions simultaneously on the plurality of communication channels. In this respect, the system according to the invention differs significantly from other mesh network technologies for IoT products, such as Thread.

In an embodiment of the present invention, at least the first or the second subnet is a wireless subnet with wireless communication channels.

While the advantages of the present invention have been described above in particular for the embodiment of the communication channels as wireless (radio) communication channels, the system according to the invention can also be implemented in a wired manner. The communication channels of the first and second subnets are then formed on pipes or wires. The system is also particularly suitable for implementing powerline data communication.

According to the invention, the carrier frequencies of the first subnet and the second subnet must differ from each other when forwarding a data packet through the infrastructure component. Furthermore, in an embodiment of the invention, the first subnet and the second subnet each utilise a single carrier frequency.

According to the invention, the plurality of controllers serves as a sink or source of data and provides an interface for connecting a sensor or an actuator. Sensors and actuators refer to the two groups of elements that need to be networked with each other. Sensors naturally serve as data sources and actuators as data sinks.

Examples of a sensor are a light sensor, such as a phototransistor, a PIR sensor, a capacitive switch, a smoke detector, a door or window contact, a motion detector, a thermostat, an intrusion detector, a sensor for detecting an air quality value, a brightness sensor, a radar sensor, an e-bike or e-scooter sensor, a car park sensor, a dustbin sensor, a sensor based on a digital camera or a combination of these.

Examples of actuators include an electrical switch, a relay and an electromechanical actuator or a combination thereof.

In an embodiment of the invention, the system comprises a plurality of controllers, and a plurality of sensors or actuators, wherein at least one sensor or actuator is connected to each interface of a controller. In this embodiment, the sensor or actuator is part of the system.

In a further embodiment, the system comprises at least one element to be switched, controlled or regulated by an actuator and connected to the actuator, in particular a luminaire, for example a ceiling light or a street light, a charging station for electric cars, scooters, bicycles, a control cabinet, a sub-distribution board, a built-in socket or an adapter plug. The element is connected to the data processing device of a controller via the actuator and the interface. The actuator receives a switching command for switching, controlling or regulating the element via the controller.

In an embodiment of the invention, the at least one infrastructure component is also a controller in addition to its function as a ‘bridge’ or repeater between the first and the second subnet. For this purpose, in an embodiment of the invention, the at least one infrastructure component also comprises an interface for connecting at least one sensor or an actuator. In an embodiment of the invention, the interface is connected to at least one sensor or actuator. In such an embodiment, the sensor or the actuator is part of the system.

In an embodiment of the invention, the infrastructure component is connected to a network for transmitting and distributing electrical energy (colloquially known as the ‘power grid’). This is used to supply power to the data processing device and the transceivers. However, in an embodiment of the infrastructure components with an interface for a sensor or actuator the connection to the power grid makes it possible to supply the sensor or the actuator or a consumer connected via the actuator, for example a luminaire, with mains voltage.

While the system according to the invention comprises exactly a first and a second subnet in the simplest embodiment, the system comprises more than two subnets in an embodiment. It is understood that in an embodiment each subnet then exclusively comprises carrier frequencies of its communication channels which are different from the carrier frequencies of all other subnets. In an alternative embodiment, it is sufficient to require that those subnets for which there is a risk of crosstalk between the communication channels of the subnets comprise carrier frequencies that differ from one another. Typically, it is necessary to require that adjacent subnets have carrier frequencies that differ from one another, while sufficiently spaced subnets can use the same carrier frequency.

In an embodiment of the invention, each of the plurality of subnets uses exactly one carrier frequency that is different from the carrier frequencies of all other subnets. This carrier frequency is used for all intra-subnet communication.

In a basic configuration with exactly one first and one second subnet, the system basically only requires a single infrastructure component which is responsible for forwarding the data packets from the first subnet to the second subnet or vice versa. However, embodiments of the invention are advantageous in which, even in a configuration with exactly one first and one second subnet, a plurality of infrastructure components are provided which take over the forwarding of data traffic between the first subnet and the second subnet. This applies even more to embodiments with more than two subnets.

In an embodiment, a data processing device within the meaning of the present invention is a computer comprising a processor.

In an embodiment of the invention, the data processing device of the at least one infrastructure component is configured such that it analyses whether the received data packet is to be forwarded or not.

In an embodiment comprising a plurality of infrastructure devices, each of the data processing devices of said plurality of infrastructure components is so configured. In an embodiment of the invention, the data processing device of the at least one infrastructure component is configured to carry out routing of the received data packet. It is understood that when the system comprises a plurality of infrastructure components, each of the data processing devices of these infrastructure components carries out this function.

In an embodiment of the invention, the data processing device of the at least one infrastructure component is configured to select a following infrastructure component to which it forwards the data packet based on information selected from a position of the following infrastructure component, a signal attenuation, a signal interference or a number of elements in the first or second subnet and data traffic, or a combination thereof.

According to an embodiment of the present invention, the at least one infrastructure component comprises a receiver for signals from a global navigation satellite system connected to the data processing device, or the data processing device of the at least one infrastructure component is configured to determine a position of the infrastructure component using a signal delay measurement. In this way, the position of the at least one infrastructure component can be used for the routing of the packet forwarding. It is understood that in an embodiment comprising a plurality of infrastructure components, each is arranged in this manner.

In an embodiment of the present invention, at least one infrastructure component in the first or the second subnet is arranged such that, when a further infrastructure component or a further controller is registered for the respective subnet, it checks whether or not an upper limit for the number of infrastructure components and controllers in this subnet has been exceeded and, if the upper limit has been exceeded, refuses to register the further infrastructure component or the further controller.

According to an embodiment, if the registration of the further infrastructure component or the further controller is refused, a further subnet is opened and the further infrastructure component or the further controller is registered there.

According to an embodiment of the present invention, the data processing device of the at least one infrastructure component is configured such that the data processing device assigns the carrier frequency of the second communication channel at least load-dependent or indifference-dependent.

In an embodiment of the present invention, the system comprises at least one router for transmitting the data packet within at least the first or the second subnet. It is understood that, in an embodiment as set out above, such a router is formed by the at least one infrastructure component.

In an embodiment of the present invention, the system comprises at least one router for connecting the system to a data network. An example of such a data network to which the system is to be connected is the Internet. In an embodiment of the invention, such a router for connecting the system to a data network is a dedicated and specialised EDGE router. In an alternative embodiment, such a router is formed by an infrastructure component as previously described for forwarding a data packet between the first subnet and the second subnet.

In an embodiment of the invention, the at least one infrastructure component has more than two transceivers. Such an infrastructure component can take over communication from a first subnet to a plurality of further subnets. If the infrastructure component in such an embodiment is a router for connecting the system to a data network to which the system is to be connected, the data throughput between the data network and the subnets of the system according to the invention is multiplied in this way.

In an embodiment of the invention, such an infrastructure component with more than two transceivers is connected to or forms a router, wherein the router connects the system to a data network, for example the Internet. In an embodiment, such an infrastructure component with n transceivers distributes data packets to n-1 subnets, wherein n is larger than two. In an alternative embodiment, such an infrastructure component with n transceivers connects n-1 systems according to the invention to a data network. In an embodiment of the invention, this infrastructure component forms a backbone that interconnects the n-1 systems. There is no direct communication between the subnets of one of the n-1 systems with the subnets of another of the n-1 systems.

In an embodiment of the invention, at least the first subnet or the second subnet is a meshed subnet.

In an embodiment of the invention, the carrier frequencies of the first subnet and the carrier frequencies of the second subnet are selected from the frequencies of a single carrier frequency band. In principle, all carrier frequency bands that make it possible to implement a plurality of communication channels with carrier frequencies that differ from one another are suitable. An example of a suitable band is the 2.4 GHz ISM band.

Further advantages, features and possible applications of the present invention become apparent from the following description of an embodiment and the associated figures. In the figures, identical elements are denoted by identical reference numbers.

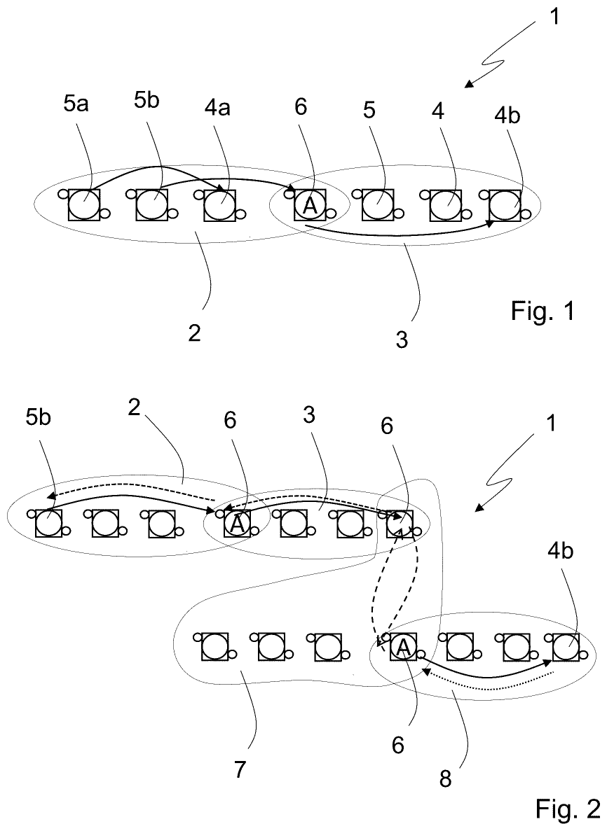

FIG. 1 is a schematic representation of a first embodiment of the system according to the invention.

FIG. 2 is a schematic representation of a further embodiment of the system according to the invention.

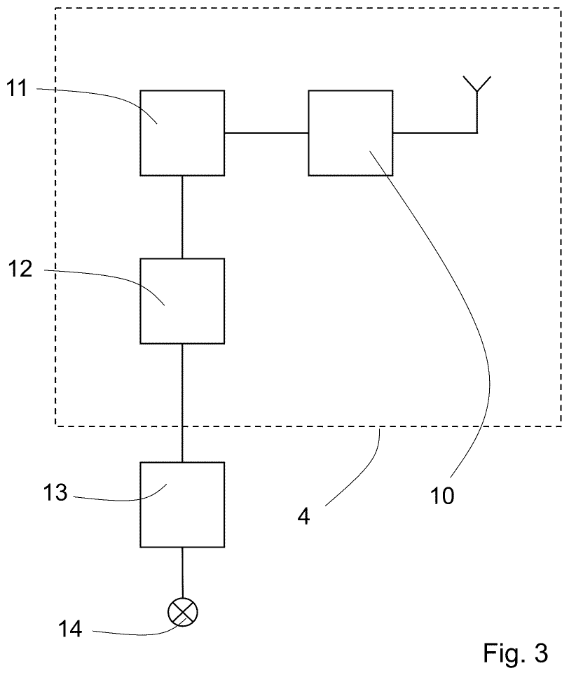

FIG. 3 is a block diagram of a controller forming part of the systems shown in FIGS. 1 and 2.

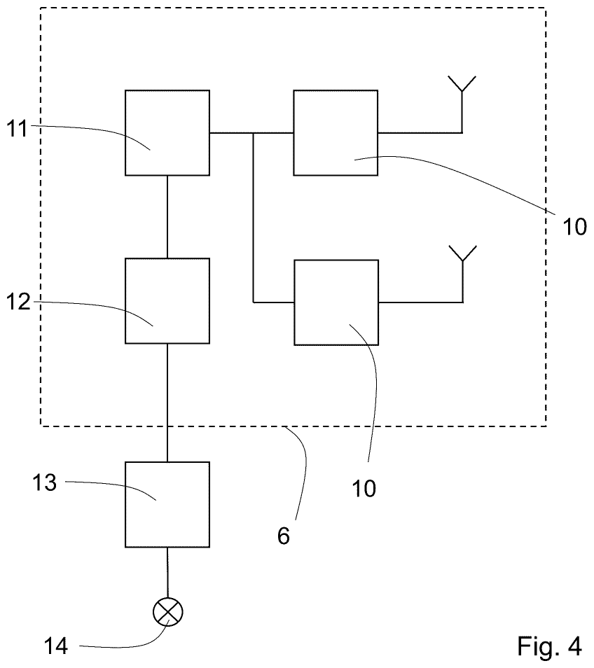

FIG. 4 is a block diagram of an infrastructure component, as it forming part of the systems of FIGS. 1 and 2.

FIG. 1 illustrates an example of a system 1 with two meshed subnets 2, 3. Each of the subnets operates with its own carrier frequency from the 2.4 GHz ISM frequency band. This pre-vents crosstalk between the two subnets 2, 3. Communication within each of the two subnets 2, 3 takes place at the carrier frequency specified for the respective subnet 2, 3.

In FIGS. 1 and 2, the elements of system 1 labelled with the reference number 4 are controllers which are connected to actuators, in this case relays, via their interfaces. The actuators are used to switch lights.

The elements labelled with the reference number 5 are controllers whose interfaces are connected to twilight sensors. If the sensors detect a brightness value below a certain threshold, they trigger the lights connected to the controller 4 to switch on, for example.

To do this, the controller 5a, for example, sends a packet within the first subnet 2 to the controller 4a so that the connected light is switched on there.

However, the controller 5b from the first subnet 2 is to be used to switch on a luminaire that is connected to the controller 4b from the second subnet 3. For this purpose, the controller 5b sends a data packet with a control signal via a first communication channel comprising the carrier frequency of the first subnet 2. This data packet is received by an infrastructure component 6 and transmitted on a second communication channel, which comprises the carrier frequency of the second subnet 3. The controller 4b receives this data packet and triggers the switching command for the actuator connected to the controller 4b.

The system 1 in FIG. 2 has increased complexity in that it comprises four subnets 2, 3, 7, 8. Each of these subnets 2, 3, 7, 8 comprises a plurality of infrastructure components 6 that are capable of simultaneously receiving signals from a first subnet and transmitting signals to a second subnet via two transceivers. In addition, the subnet provided with the reference number 2 is connected to the Internet via an EDGE router 9.

FIG. 3 illustrates a controller 4 comprising a single transceiver 10 for connecting the controller 4 to a single communication channel of a single subnet. The transceiver 10 is connected to a data processing device 11, which in turn is connected to an interface 12. As an example, the interface 12 is connected to a luminaire 14 via a relay 13 as an actuator.

FIG. 4 schematically illustrates an infrastructure component 6 according to an embodiment of the present invention. The infrastructure component 6 comprises two transceivers 10 for connecting the infrastructure component 6 to two communication channels with different carrier frequencies, which belong to two different subnets. The transceivers are connected to a data processing device 11. The data processing device 11 performs a routing function when connecting the two subnets. When forwarding a data packet, it is received on a first communication channel of one subnet and transmitted on a second communication channel of the second subnet. In the embodiment shown, the infrastructure component 6 also serves as a controller for controlling a light 14. For this purpose, the infrastructure component 6 also has an interface 12 for connecting an actuator. In the figure, the interface is connected to the actuator, which in turn is connected to the luminaire.

For the purposes of the original disclosure, it is pointed out that all features, as they are apparent to a person skilled in the art from the present description, the drawings and the claims, even if they have been described specifically only in connection with certain further features, can be combined both individually and in any combination with other features or groups of features disclosed here, unless this has been expressly excluded or technical circumstances make such combinations impossible or meaningless. A comprehensive, explicit description of all conceivable combinations of features is omitted here only for the sake of brevity and readability of the description.

Whilst the invention has been illustrated and described in detail in the drawings and the preceding description, this illustration and description is given by way of example only and is not intended to limit the scope of protection as defined by the claims. The invention is not limited to the disclosed embodiments.

Variations of the disclosed embodiments will be obvious to those skilled in the art from the drawings, the description and the appended claims. In the claims, the word ‘comprising’ does not exclude other elements or steps, and the indefinite article ‘one’ or ‘a’ does not exclude a plurality. The mere fact that certain features are claimed in different claims does not exclude their combination. Reference numbers in the claims are not intended to limit the scope of protection.

### LIST OF REFERENCE NUMBERS

1 System
2, 3, 7, 8 Subnet
4,4a, 4b Controllers connected to actuators
5, 5a, 5b Controllers connected to sensors
6 Infrastructure component
9 EDGE router
10 Transceiver
11 Data processing device
12 Interface
13 Relay
14 Luminaire

1. A system comprising:
a plurality of meshed, packet-based communication channels for full-duplex signal transmission;
a plurality of controllers as data receivers or data sources, wherein each of the plurality of controllers comprises:
an interface for connecting at least one sensor or an actuator
a data processing device, and
exactly one transceiver
wherein the exactly one transceiver is connected to exactly one of the plurality of communication channels at any point in time; and
at least one infrastructure component, wherein the at least one infrastructure component comprises:
a data processing device and
at least two transceivers
wherein each of the at least two transceivers is connected to exactly one of the plurality of communication channels at any point in time,
wherein the plurality of communication channels are divided between at least a first subnet and a second subnet wherein all carrier frequencies of a signal transmission in the first subnet are different from all carrier frequencies of the signal transmission in the second subnet,
wherein the system is configured to transmit a signal with a data packet to and from one of the plurality of controllers wherein the transmitting of the signals comprises forwarding of the data packet by the at least one infrastructure component, wherein in the forwarding the at least one infrastructure component receives the data packet on a first of the plurality of communication channels and transmits the data packet on a second of the plurality of communication channels, and
wherein the first communication channel is part of the first subnet and the second communication channel is part of the second subnet.

2. The system according to claim 1, wherein the data processing device of the at least one infrastructure component is configured such that the data processing device analyzes whether the received data packet is to be forwarded or not.

3. The system (1) according to claim 1, wherein the data processing device of the at least one infrastructure component is configured such that the data processing device carries out a routing of the received data packet.

4. The system according to claim 1, wherein the data processing device of the at least one infrastructure component is configured such that the data processing device selects a following infrastructure component to which it forwards the data packet on the basis of information selected from a position of the following infrastructure component, a signal attenuation, a signal interference, or a number of elements in the subnet and the current data traffic, or a combination thereof.

5. The system according to claim 1, wherein the at least one infrastructure component comprises a receiver for signals of a global navigation satellite system or the data processing device of the at least one infrastructure component is configured such that it determines a position of the infrastructure component by means of a signal delay measurement.

6. The system according to claim 1, wherein the data processing device of at least one infrastructure component is configured such that the data processing device assigns the carrier frequency of the second communication channel at least load-dependent or interference-dependent.

7. The system according to claim 1, wherein the at least one infrastructure component comprises an interface for connecting at least a sensor or an actuator.

8. The system according to claim 1, wherein the system comprises at least one router for transmitting the data packet within at least the first or the second subnet.

9. The system according to claim 1, wherein the system comprises at least one router for connecting the system to a data network.

10. The system according to claim 1, wherein at least the first or the second subnet is a wireless subnet.

11. The system according to claim 1, wherein at least the first subnet or the second subnet is a meshed subnet.

12. The system according to claim 11, wherein the carrier frequencies of the first subnet and the carrier frequencies of the second subnet are selected from the frequencies of a single carrier frequency band,
